(19) United States
(12) Patent Application Publication
(10) Pub. No.: US 2007/0074683 A1
(43) Pub. Date: Apr. 5, 2007

(54) Far Infrared Emitting Compositions and Devices Using the Same for Improving Fuel Consumption and Exhaust Gas of Internal Combustion Engines

(76) Inventors: Yasutaka Matsuo, Fukuoka-City (JP); In-Soo Chung, Kwangju-Si (KR); Takashi Watanabe, Kurume-city (JP)

Correspondence Address: GRAYBEAL, JACKSON, HALEY LLP, 155 - 108TH AVENUE NE, SUITE 350, BELLEVUE, WA, 98004-5901, US

(21) Appl. No.: 11/534,913

(22) Filed: Sep. 25, 2006

Related U.S. Application Data
(60) Provisional application No. 60/720,115, filed on Sep. 23, 2005.

(51) Int. Cl. F01P 9/00; F02M 27/00

(52) U.S. Cl. 123/41.01; 123/538

(57) ABSTRACT

A device containing a far infrared radiation-emitting material over which fuel or other fluids such coolant fluid can flow such that far infrared radiation is emitted into the liquid fuel or coolant resulting in the reduction of toxic exhaust gas and the improvement of the combustion efficiency. The compositions includes a material that can emit far infrared radiation, such as magnetite or quartz-feldspar porphyry. Generally, the far infrared radiation emitting material is contained in a matrix that radiation being emitted to disperse out of the matrix and into the surrounding environment. The preferred matrix is a glass composition even though other materials such as plastics may be used. Preferably the glass composition is in the form of glass beads, which can be any shape but preferably pellets or balls. Also the far infrared radiation-emitting material can be embedded in other materials such as clear plastic, clear silicone or clear fiberglass beads.

### CROSS-REFERENCE TO RELATED APPLICATIONS

The present application claims priority from U.S. provisional patent application No. 60/720,115 filed on Sep. 23, 2005, which is incorporated herein by reference in its entirety and for all its teachings and disclosures.

### BACKGROUND OF THE INVENTION

Internal combustion engines of automobiles, marine vessels and the like, which use liquid fuels, emit carbon monoxide (CO) and hydrocarbons (HC) as undesirable byproducts due to incomplete combustion of the fuel; exhaust gas containing these byproducts is a cause of air environmental pollution, and has come to be a social problem. Various methods have been proposed for suppressing emission of such exhaust gas and for improving the combustion, and improvement of fuel composition and improvement of the engine per se had been carried out as major approaches to solution. However, stable effects of these improvements had not been obtained.

A fuel consumption improving filter using a ceramic as a far infrared emitting ingredient is disclosed, for example, in Japanese Laid-Open Patent Disclosure No. Hei 7 77114 2. It describes a far infrared emitting ceramic material configured as a pellet, or as a mold filer with through-holes formed therein, or as a filter having the ceramic material coated on a mesh-formed resin component, a metal component, a wire component and the like; these components are furnished to a fuel line and an intake air line, and allow the fuel and intake air to pass, thereby finely cleaving hydrogen bond population of water molecules, activating the molecular actions, and consequently improving the fuel consumption. As the far infrared emitting ceramic is sintered at a relatively low temperature, however, elution of the ingredients occurs over a long period of use, and causes various adverse influences such as contamination of the eluted ingredients into the fuel.

Thus, there is a need to provide a fuel device and a coolant purifier which do not use elution of far infrared emitting ingredients even under various conditions, which are capable of expressing and sustaining the far infrared emitting effect, and which are capable of reducing the exhaust gas and of improving the combustion efficiency without elution into the fuel or coolant.

### SUMMARY OF THE INVENTION

The present invention is directed to a device containing a far infrared radiation emitting composition, which is preferably a ceramic in the shape of beads, over which fuel or other fluids such as radiator coolant fluid for use in an internal combustion engine can flow. Through exposure of such fluids to the far infrared radiation emitted into the fuel or coolant fluid by the composition, a reduction in exhaust gas toxins and an improvement in combustion efficiency can be achieved. The composition comprises any material that can emit far infrared radiation and is preferably disposed in a matrix that allows for the far infrared radiation being emitted to disperse out of the matrix and into the surrounding environment, which in the environment of an internal combustion engine is liquid fuel or coolant. The preferred matrix comprises glass, although other materials such as plastics may be used. Preferably, the glass composition is in the form of glass beads, which can be any shape, such as polygons, ovoid, spheres, cones, cylinders, etc. although spheres, pellets or balls are preferred.

Embodiments of the present invention comprise a housing that defines a chamber, preferably cylindrical, and at least one conduit fluidly coupling the chamber to the environment. Disposed in the chamber is a composition comprising a far infrared emitting material and preferably silicon dioxide. In one series of embodiments, the composition comprises a 1 to 50 wt % of quartz-feldspar porphyry as the far infrared emitting material; in another series of embodiments, the composition comprises a 1 to 50 wt % of magnetite as the far infrared emitting material; in yet another series of embodiments, the composition comprises a 1 to 50 wt % of quartz-feldspar porphyry and magnetite as the far infrared emitting material. Thus, fluid associated with the internal combustion engine will be exposed to far infrared radiation when such fluid is directed to the at least one orifice. To facilitate return of the fluid to its intended destination, many embodiments of the invention provide for two fluid conduits, namely, an inlet and an outlet, and may be constituted as a filter or similar element. Such embodiments may be positioned “inline” with existing fluid conduits such as external fuel supply lines or coolant circulation lines. Otherwise, embodiments having only one fluid conduit or more than two fluid conduits can be disposed in the fluid flow, such as in an expansion chamber or overflow vessel associated with the coolant system, or in a fuel reservoir such as a fuel tank or emissions control subsystem.

The physical geometry of the composition is variable, but preferably is formed as discrete elements such as beads of any shape including cubic, rectangular, spherical and the like. The discrete elements are retained within the chamber and are either sized larger than the at least one conduit or are prevented from traversing there through by suitable prevention means such as a screen or other foraminous element. The selection of discrete elements simplifies the manufacturing process and permits introduction of the elements into a variety of containers, chambers, and similar structure.

### BRIEF DESCRIPTION OF THE DRAWINGS

FIG. 1 is an explanatory drawing showing ingredients and far infrared emitting characteristics of the glass composition of the present invention.

FIG. 2 is an explanatory drawing showing angle of contact with water droplet on the glass composition according to Example 1.

FIG. 3 is an explanatory drawing showing angle of contact with water droplet on a soda-lime glass.

FIG. 4 is a sectional view showing the fuel device containing glass composite beads of the present invention.

FIG. 5(a) is a plan view of the coolant device according to Example 3 of the present invention, and FIG. 5(b) is a sectional view of the coolant device according to Example 3 of the present invention.

FIG. 6 is a schematic explanatory drawing wherein the coolant device containing glass pellets of the present invention.

FIG. 7 is a device for radiator coolant. The device contains glass composite beads of the present invention as shown in FIG. 4.

FIG. 8 shows a device containing glass composite beads of the present invention lowered in a reservoir containing radiator coolant and schematically shows the coolant circulating through the device being energized with far infrared radiation and circulating throughout the engine.

### DETAILED DESCRIPTION OF THE INVENTION

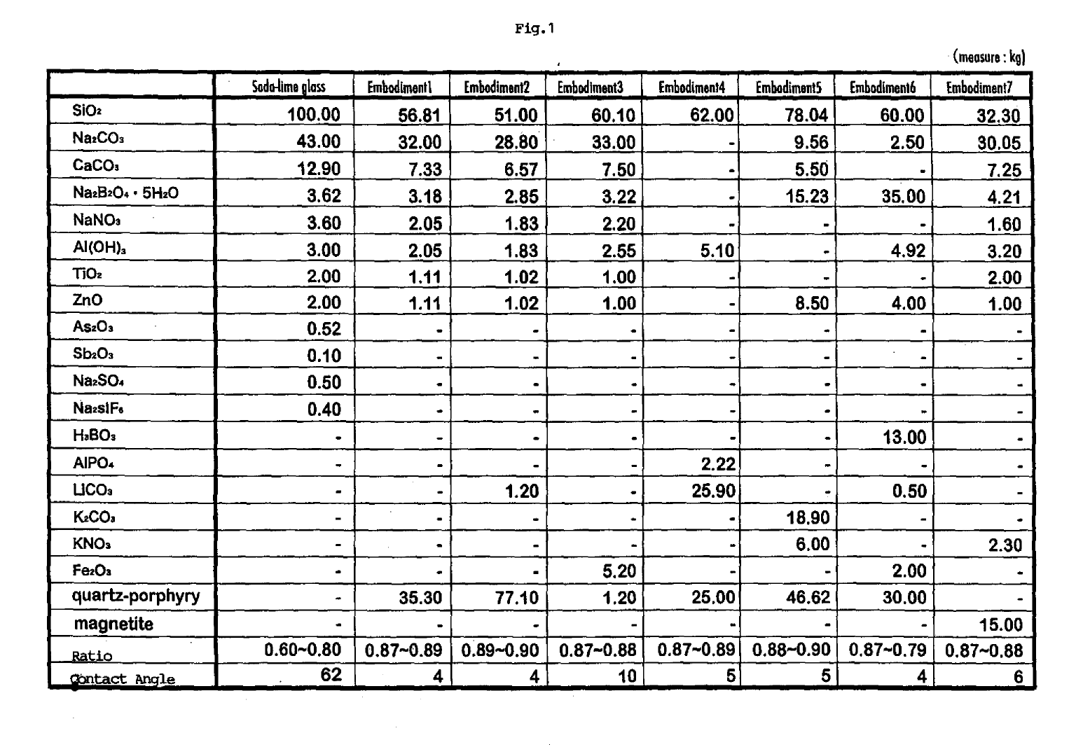

The glass composition of the present invention is made as a product by homogeneously mixing in varying quantities the ingredients illustrated in FIG. 1, and by melting the mixture at a predetermined temperature (1,300° C. to 1,400° C.) and vitrifying them, followed by molding and cooling gradually.

It is possible to produce by the same process as soda-lime glass. When the glass ingredient has a content of 50 wt % or less, the glass becomes unstable and renders the glass impractical. When the quartz-feldspar porphyry source material has the content of less than 1 wt %, its effect is lost; when the content is more than 50 wt %, not only vitrifying the composition becomes difficult, but also the transparency of the glass product is ruined. Any source materials generally used as glass ingredients can be introduced without interfering the object of the present invention, as long as their contents fall within 10 wt %. It was also elucidated that magnetite available from the same location as the quartz-feldspar porphyry source material has the same glass characteristics as those of the quartz-feldspar porphyry. Quartz-feldspar porphyry is also known as adamantine stone or Elvan stone.

According to an embodiment of the present invention, the first and second glass balls have SiO₂ as a major ingredient, and the far infrared emitting ingredients will not elute even under various conditions, since ingredients such as Al₂O₃ and the like are effectively added from the quartz-feldspar porphyry and the magnetite source materials to the glass. Thus, it is possible to exhibit and sustain the far infrared radiation effect for a long duration of time. It is possible to reduce the cluster in the liquid fuel and thereby to combust in a manner more closer to complete combustion as compared with the case where a liquid fuel having larger clusters is combusted, because the far infrared 21 radiation from quartz-feldspar porphyry, which is a natural stone in the first glass balls, and magnetic emission (or irradiation of electromagnetic wave) from magnetite, which is a magnetic iron ore in the second glass balls, are received by the liquid fuel. The liquid fuel, therefore, can be improved in the combustion efficiency, can be reduced in the consumption by approximately 10 to 15%, and the engine output can be improved, after being passed through the fuel device which contains the far infrared radiation ingredients. Furthermore, it is possible to accomplish the improvement of the fuel consumption and reduction of the odor by a synergistic effect of the first and second glasses. By applying the fuel device of the present invention to the automobiles, it is possible to reduce the exhaust gas concentration by approximately 20 to 50%, and to improve the engine output. Because the fuel device containing such far infrared emitting ingredients also has a deodorizing effect, it is possible to deodorize the exhaust gas odor and the combustion odor, and to thereby improve the environment when starting or running the engine.

Another embodiment of the present is a coolant accessory having first glass balls which contain 1 to 50 wt % of a quartz-feldspar porphyry and 50 to 99 wt % of a glass composition mainly composed of SiO₂, and second glass balls which contain 1 to 50M % of magnetite and 50 to 99 wt % of a glass composition mainly composed of SiO₂, characterized by the first glass balls and the second glass balls being filled in a container made of stainless steel, resin or the like.

The far infrared emitting ingredients contained in the glass composition of the present invention do not elute even under various conditions, since the first and second glass balls have SiO₂ as a major ingredient, and ingredients such as Al₂O₃ and the like are effectively added from the quartz-feldspar porphyry and the magnetite source materials to the glass. Thus, it is possible to exhibit and sustain the far infrared radiation effect for a long duration of time. By being irradiated with the far infrared radiation from the first and second glass balls, the coolant is purified and becomes less likely to be dirty, and it is possible to prevent impurities in the coolant from being stuck inside a reservoir tank, and to remove the impurities. Thus, rust is reduced on components made of iron with which the coolant is brought into contact, and performance of the coolant is further improved. Because the first or second glass balls are hydrophilic glass, the coolant can be purified by itself on the surface of the glass. In addition, electromagnetic wave emitted from the second glass balls forms an electric field around the engine, and thereby allows the liquid fuel to combust more rapidly and completely by the Asakawa Effect. Consequently, it was possible to improve the fuel consumption of the internal combustion engine, and to halve the exhaust gas such as hazardous carbon monoxide (CO), hydrocarbons (HC) and the like.

The fuel accessory and coolant accessory or devices of the present invention have a far infrared emitting function, an electromagnetic wave emitting function, a surface hydrophilization function, an antibacterial function, a deodorizing function, a reducing activity function, a water purifying function and the like, by quartz-feldspar porphyry as an ingredient of 16 the first glass balls and by magnetite as an ingredient of the second glass balls. It is preferable that the fuel and the coolant accessories of the present invention are attached to combustion line and water handling lines of gasoline engine cars and diesel engine cars in particular, but it is also allowable to use them to such fuel lines as boiler-related equipment, private power generators, kerosene heaters, fan heaters which use other liquid fuels and the like.

Below is the detailed description of examples of the present invention with reference to the attached drawings, although the present invention is not limited by these examples.

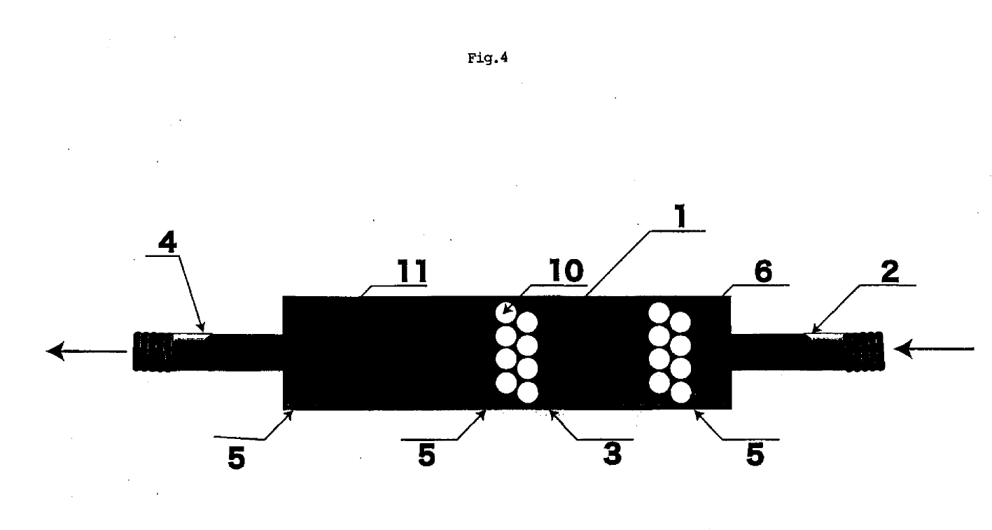

FIG. 4 is a sectional view showing an example of a fuel device 1 having the first and second glass balls 11, 12 which contain the far infrared emitting ingredients. As shown in the drawing, the fuel device 1 has a cylindrical container 3 having a fuel inlet 2 consisting of a round pipe of approximately 7 to 10 mm in diameter formed at one end, and a fuel outlet 4 also consisting of a round pipe of approximately 7 to 10 mm in diameter formed at the other end thereof. The cylindrical container 3 is approximately 20 to 100 mm in diameter and approximately 10 to 500 mm in length, and, at one end of the inlet 2 side, has an approximately 50-mm gap 6 in which a plurality of the first glass balls 10 and the second glass balls 11 are filled. By providing the gap 6, the fuel coming through the inlet 2 is allowed to uniformly spread over the entire portion of the container 3, which is larger than the diameter of the pipe of the inlet 2. In the container 3, metal plates composed of a stainless steel (SUS steel) mesh to hold the first and second glass balls 10, 11 are provided at three locations, on the inlet 2 side, on the outlet 4 side, and between the first 16 glass balls 10 and the second glass balls 11, so as to prevent the first and second glass balls 10, 11 from flowing off the container 3, and furthermore, to avoid mixing of the first and second glass balls 10, 11. The metal plates are formed so as to match the sectional size of the cylindrical container 3.

Ingredients of the first glass balls 10 of the present example include 40.0 wt % SiO₂, 20.5 wt % Na₂CO₃, 5.0 wt % CaCO₃, 4.2 wt % Na₂B₂O₄.5H₂O, 5.5wt % NaNO₃2.0 wt % Al(OH) 3, 1.0 wt % TiO₂, 1.0 wt % ZnO, 1.0 wt % Li₂CO₃ and 19.8 wt % quartz-feldspar porphyry, and ingredients of the second glass balls 11 include 45.0 wt % SiO₂, 15.8 wt % Na₂CO₃, 4.0 wt % CaCO₃, 4.2 wt % NaNO₃, 1.5 wt % Al(OH) 3, 1.5 wt % ZnO, 3.0 wt % KNO and 25.0 wt % magnetite. The first and second glass balls 10, 11 are obtained by homogeneously mixing glass composed of respective ingredients, melting at a temperature of 1,300 to 1,400° C., molding the vitrified product into spheres, and then allow them to cool. Mean diameter of the first and second glass balls 10, 11 is approximately 5 to 13 mm.

Below is the description of actions in the above-mentioned configuration. Fuel liquid such as gasoline, light oil, kerosene, heavy oil or the like flows into the container 3 through the inlet 2, passes through the gap of the mesh metal plate 5, further passes sequentially through the first glass balls 10, the metal plate 5, the second glass balls 11, and the metal plate 5 to reach the outlet 4, and flows out from the outlet 4. The liquid fuel in this case can combust in a manner closer to complete combustion as compared with the case where a liquid fuel having larger clusters is combusted, because it is possible to reduce the cluster of the liquid fuel by being irradiated with far infrared radiation and electromagnetic wave from the first and second glass balls 10, 11 which contain the far infrared emitting ingredients. Thus, the liquid fuel, after being passed through the fuel device 1 which contains the far infrared radiation ingredients of the present invention, has an increased combustion efficiency, and can reduce the fuel by approximately 10 to 15%. The fuel device 1 containing the far infrared emitting ingredients also has a deodorizing effect, and can remove offensive odor during the combustion. By combining the first and second glass balls 10, 11, through their synergistic effect, it is possible to further accomplish improvement of the fuel consumption and reduction of the odor during the combustion. Moreover, the far infrared emitting ingredients do not elute even under various conditions, because the first and second glass balls 10, 11 are mainly composed of SiO₂, and the ingredients such as Al₂O₃ and the like are effectively added from the quartz-feldspar porphyry and the magnetite source materials to the glass. Therefore, it is possible to express and sustain the far infrared radiation effect for a long duration of time.

As stated above, in the present example, the liquid fuel can combust in a manner closer to complete combustion as compared with the case where a liquid fuel having larger clusters is combusted, because the cluster of the liquid fuel is reduced by being irradiated with far infrared radiation from quartz-feldspar porphyry, which is a natural stone in the first glass balls 10, and with magnetic emission (or 11 irradiation of electromagnetic wave) from magnetite, which is a magnetic iron ore in the second glass balls 11, by means of the fuel device 1 having the first glass balls 10 which contain 1 to 50 wt % of quartz-feldspar porphyry and 50 to 99 wt % of the glass composition mainly composed of SiO₂; and the first glass balls 11 which contain 1 to 50 wt % of magnetite and 50 to 99 wt % of the glass composition mainly composed of SiO₂, wherein the first glass balls and the second glass balls 10, 11 are filled in the cylindrical container 3 which has the fuel inlet 2 and the fuel outlet 4. Thus, the liquid fuel, after being passed through the fuel device 1 which contains the far infrared radiation ingredients, can improve the combustion efficiency , can reduce the fuel by approximately 10 to 15%, can improve the engine output, and can decrease, as compared with conventional cases, the exhaust gas containing carbon monoxide (CO) and hydrocarbons (HC), which are byproducts caused by incomplete combustion. Moreover, it is possible to improve the fuel consumption and to decrease the odor by synergistic effect of the first and second glass balls 10, 11. By applying the fuel device 1 of the present invention to the automobiles, it is possible to decrease concentration of hazardous exhaust gas by approximately 20 to 50%, and to improve the engine output. In addition, as the fuel device 1 containing the far infrared emitting ingredients also has a deodorizing effect, it is possible to remove the exhaust gas odor or combustion odor, and to improve the environment when starting or running the engine. Furthermore, because the first and second glass balls 10, 11 contain the glass composition mainly composed of SiO₂, the far infrared emitting ingredients do not elute even under various conditions, and raise no risk of exerting any adverse influences. Consequently, it is possible to express and sustain the far infrared emitting effect for a long duration of time. In addition, the fuel device 1 of the present invention can be used for a long duration of time, only with such maintenance as cleaning of the first and second glass balls and the like.

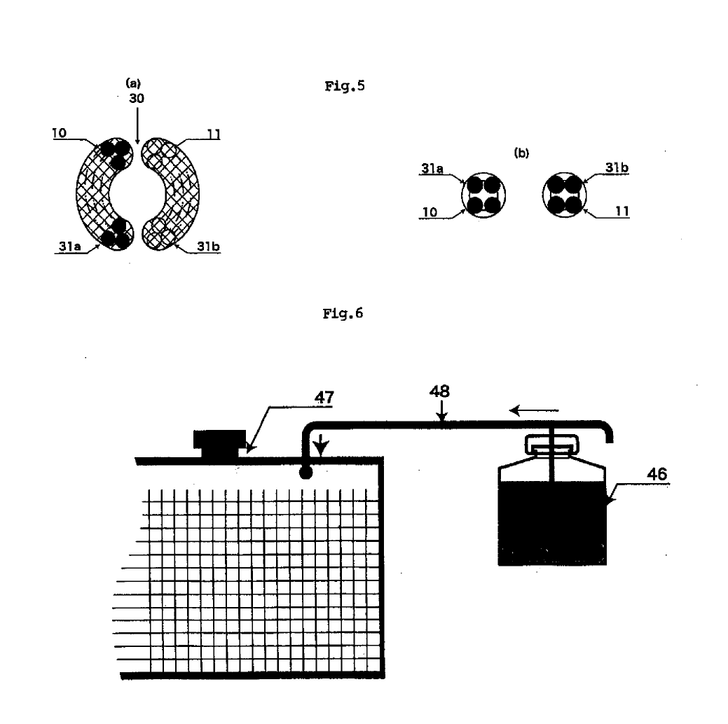

FIG. 5 and FIG. 6 illustrate an example for the present invention, and any components which are the same as those in the above-mentioned example are given with same reference numerals, describing without detailed explanations therefore. FIG. 5(a) is a plane view showing a coolant device 30 of the present invention, and as shown in the drawing, a plurality of the first and second glass balls 10, 11 are respectively filled in bags 31a, 31b made of polyethylene, or rubber or the like which are publicly-known and elastic. Placement of the first and second glass balls 10, 11 together in a stainless-steel cylinder (non-elastic) raises no difference in the effect. Each of the bags 31a, 31b is configured as a mesh, so as to allow them to efficiently express the water devicefying function with far infrared radiation and the like by contacting the first and second glass balls 10, 11 with the coolant and by irradiating the coolant with far infrared radiation. The mesh size is no specifically limited as long as the first and second glass balls 10, 11 do not drop out of the bags. Both ends of the elastic bag 31a with the first glass balls 10 filled therein, and the bag 31b with the second glass balls 11 filled therein are obstructed. The same effect is obtained when the first and second glass balls 10, 11 are put in the same bag. FIG. 5(b) is a sectional view of the coolant device 30, and the bag 31a filled with the first glass balls 10 and the bag 31b filled with the second glass balls 11 have near circular sections, so as to allow a plurality of the first and second glass balls 10, 11 deposited therein. The bags 31a, 31b have a near-U-shape, and together form an annular shape by opposing one end of the bag 31a filled with the first glass balls 10 with one end of the bag 31b filled with the second glass balls 11, and by opposing the other end of the bag 31a with the other end of the bag 31b.

FIG. 6 is a partially-sectioned schematic explanatory drawing showing one embodiment of the coolant device 30 attached in a reservoir tank 46 of a radiator 47. The publicly-known reservoir tank 46 filled with a coolant is connected via a pipe 48 to the radiator 47, and the coolant device 30 of the present invention is disposed on the bottom of the reservoir tank 46 so as to surround the pipe 48 inserted into the reservoir tank 46.

Below is the description of actions in the above-mentioned configuration. The coolant in the reservoir tank 46 is purified with far infrared radiation irradiated by the first and second glass balls 10, 11 of the coolant device 30, becomes less likely to be dirty, can prevent impurities in the coolant from being stuck inside the reservoir tank 46, and can remove them. Thus, rust is reduced on components made of iron with which the coolant is brought in contact, and the performance of the coolant is further improved. Because the first or second glass balls are hydrophilic glass, it is possible to purify the coolant by itself on the surface of the glass. In addition, electromagnetic wave emitted from the second glass balls forms an electric field around the engine, and thereby allows the liquid fuel to combust more rapidly and completely by the Asakawa Effect. Consequently, it was possible to improve the fuel consumption of the internal combustion engine, and to halve the exhaust gas such as hazardous carbon monoxide (CO), hydrocarbons (HC) and the like. The far infrared emitting ingredients do not elute even under various conditions, because the first and second glass balls 10, 11 are mainly composed of SiO₂, and the ingredients such as Al₂O₃ and the like are effectively added from the quartz-feldspar porphyry and the magnetite source materials to the glass. Therefore, it is possible to express and sustain the far infrared radiation effect for a long duration of time.

As stated above, the purification is carried out with far infrared radiation irradiated by the first and second glass balls 10, 11 of the coolant device 30, and the coolant becomes less likely to be dirty, can prevent impurities in the coolant from being stuck inside the reservoir tank 46, and can remove them, because the present example, is the coolant device 30 having the first glass balls 10 which contain 1 to 50 wt % of quartz-feldspar porphyry and 50 to 99 wt % of the glass composition mainly composed of SiO₂, and the second glass balls 11 which contain 1 to 50 wt % of magnetite and 50 to 99 wt % of the glass composition mainly composed of SiO₂, characterized by the first glass balls and the second glass balls 10, 11 being filled in the net-formed bags 31a, 31b. Thus, the rust is reduced on components made of iron with which the coolant is brought in contact, and the performance of the coolant is further improved. Because the first or second glass balls are hydrophilic glass, it is possible to purify the coolant by itself on the surface of the glass. In addition, electromagnetic wave emitted from the second glass balls forms an electric field around the engine, and thereby allows the liquid fuel to combust more rapidly and completely by the Asakawa Effect. Consequently, it became possible to improve the fuel consumption of the internal combustion engine by 10% or more, and to halve the exhaust gas such as hazardous carbon monoxide (CO), hydrocarbons (HC) and the like. Furthermore, the far infrared emitting ingredients do not elute even under various conditions, and raise no risk of exerting any adverse influences, because the first and second glass balls 10, 11 are mainly composed of SiO₂, and the ingredients such as Al₂O₃ and the like are effectively added from the quartz-feldspar porphyry and the magnetite source materials to the glass. Therefore, it is possible to express and sustain the far infrared radiation effect for a long duration of time.

FIG. 1 is a table that shows total ratio of far infrared radiation emission relative to the radiation emitted from the perfect black body, which is assumed as 100 (called ratio in the table) angle of contact with water droplet (degree) for a plain glass composition and the glass compositions of the present invention.

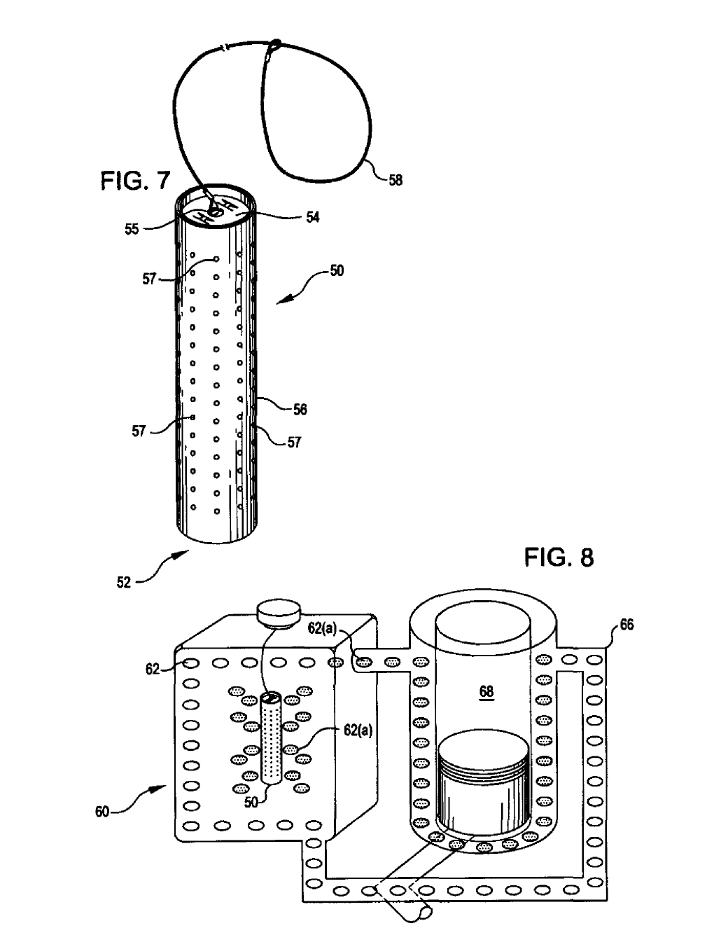

FIG. 7 shows a preferred radiator coolant device 50 of the present invention. It is a hollow tube and has a metal bottom 52 (not visible) a metal top 54 and a circular wall 56. It has an inner cavity as shown in FIG. 4 and holds the first glass balls 10 and the second glass balls 11 as shown in FIG. 4. Metal top 54 has a means 56 for metal cable 58 to connect to the top of the cylinder. Circular wall 56 has a plurality of holes 57 though which fluid can flow in and out of the interior of device 50.

FIG. 8 shows a schematic drawing of an engine 60 wherein coolant device 50 lowered is into radiator fluid 62 contained within reservoir 64 of the engine. The coolant in reservoir 64 flows through holes 57 into the interior cavity of device 50. Un-activated coolant comes into contact with the two different types of glass composite beads, 10 and 11 (FIG. 4). The coolant is activated by the far infrared radiation emitted by the glass composite beads and the activated coolant 62(a) flows out of the device and back into reservoir 64. Activated coolant 62(a) circulates through engine jacket 66, which surrounds piston 68. The activated coolant not only cools piston 68 but also emits far infrared radiation into the interior of the piston. The far infrared radiation in turn activates fuel in the piston resulting in a more complete combustion of the fuel.

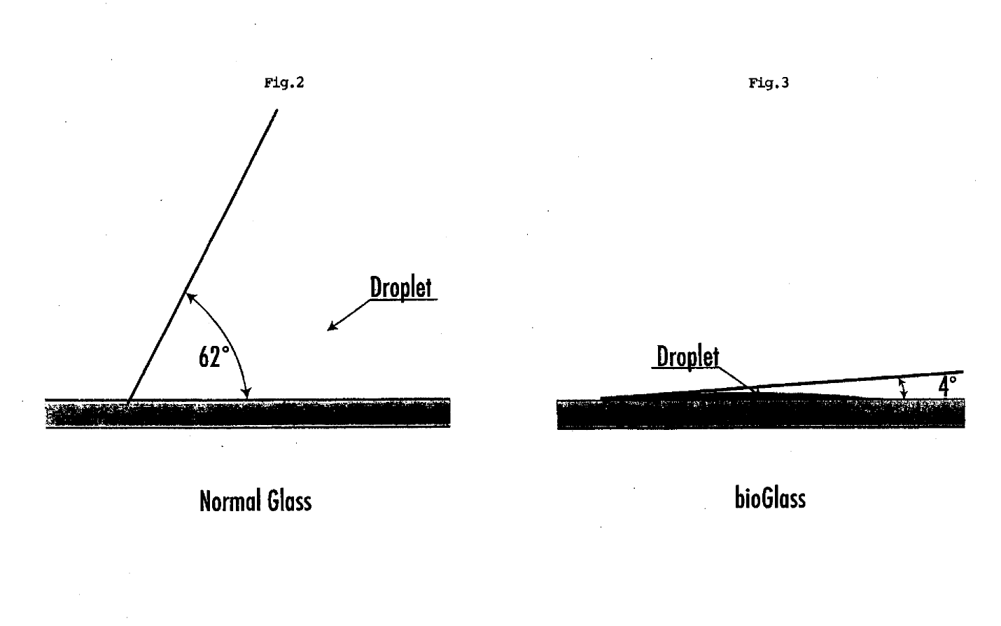

Below is the description of the glass composition of the present invention with reference to the drawings. FIG. 1 is a table showing ingredients of the glass composition of the present invention and characteristics of far infrared radiation; FIG. 2 is an explanatory drawing showing contact angle of water droplet on the glass composition according to Example 1; and FIG. 3 is a drawing showing contact angle of water droplet on a soda-lime glass.

Generally glass (soda-lime glass) is comprised of the ingredients with the mixing ratio as shown below:

| | |
|---|---|
| SiO2 | 100.00 Kg |
| Na2CO3 | 43.00 Kg |
| CaCO3 | 12.90 Kg |
| Na2B2O4•5H20 | 3.62 Kg |
| NaNO3 | 3.60 Kg |
| Al(OH)3 | 3.00 Kg |
| TiO2 | 2.00 Kg |
| ZnO | 2.00 Kg |
| As203 | 0.52 Kg |
| Sb203 | 0.10 Kg |
| Na2SO4 | 0.50 Kg |
| Na2SiF6 | 0.40 Kg |

The glass composition is manufactured by mixing these ingredients homogeneously, followed by melting at the temperature of 1,300° C. to 1,400° C., molding the vitrified product and then cooling gradually. The ratio of far infrared radiation was found to be 60 to 80% relative to the radiation emitted from the perfect black body, which is assumed as 100. The contact angle with water was shown to be 62°.

The following examples show preferred embodiments of the glass compositions of the present invention.

### EXAMPLE 1

| | |
|---|---|
| SiO₂ | 56.81 Kg |
| Na₂CO₃ | 32.00 Kg |
| CaCO₃ | 7.33 Kg |
| Na₂B₂O₄•5H₂0 | 3.18 Kg |
| NaNO₃ | 2.05 Kg |
| Al(OH)₃ | 2.05 Kg |
| TiO₂ | 1.11 Kg |
| ZnO | 1.11 Kg |
| Quartz-feldspar porphyry | 35.30 Kg |

The glass composition was manufactured by mixing these ingredients homogeneously, followed by melting at the temperature of 1,300° C. to 1,400° C., molding the vitrified product and then cooling gradually. The ratio of far infrared radiation was found to be 87 to 89% relative to the radiation emitted from the perfect black body, which is assumed as 100. The contact angle with water was shown to be 4°.

### EXAMPLE 2

| | |
|---|---|
| SiO₂ | 51.00 Kg |
| Na₂CO₃ | 28.80 Kg |
| CaCO₃ | 6.57 Kg |
| Na₂B₂O₄•5H₂O | 2.85 Kg |
| NaNO₃ | 1.83 Kg |
| Al(OH)₃ | 1.83 Kg |
| TiO₂ | 1.02 Kg |
| ZnO | 1.02 Kg |
| Li₂CO₃ | 1.20 Kg |
| Quartz-feldspar porphyry | 77.10 Kg |

The glass composition was manufactured by mixing these ingredients homogeneously, followed by melting at the temperature of 1,300° C. to 1,400° C., molding the vitrified product and then cooling gradually. The ratio of far infrared radiation was found to be 89 to 90% relative to the radiation emitted from the perfect black body, which is assumed to be 100. The contact angle with water was shown to be 4°.

### EXAMPLE 3

| | |
|---|---|
| SiO₂ | 66.10 Kg |
| Na₂CO₃ | 33.00 Kg |
| CaC0₃ | 7.50 Kg |
| 15Na₂B₂O₄•5H₂0 | 3.22 Kg |
| NaNO₃ | 2.20 Kg |
| Al(OH)₃ | 2.55 Kg |
| TiO₂ | 1.00 Kg |
| ZnO | 1.00 Kg |
| Fe₂0₃ | 5.20 Kg |
| Quartz-feldspar porphyry | 77.10 Kg |

The glass composition was manufactured by mixing these ingredients homogeneously, followed by melting at the temperature of 1,300° C. to 1,400° C., molding the vitrified product and then cooling gradually. The ratio of far infrared radiation was found to be 87 to 88% relative to the radiation emitted from the perfect black body, which is assumed as 100. The contact angle with water was shown to be 10°.

### EXAMPLE 4

| | |
|---|---|
| SiO₂ | 62.00 Kg |
| Al(OH)₃ | 5.10 Kg |
| AlPO₄ | 2.22 Kg |
| Li₂CO₃ | 25.90 Kg |
| Quartz-feldspar porphyry | 1.20 Kg |

The glass composition was manufactured by mixing these ingredients homogeneously, followed by melting at the temperature of 1,300° C. to 1,400° C., molding the vitrified product and then cooling gradually. The ratio of far infrared radiation was found to be 87 to 89% relative to the radiation emitted from the perfect black body, which is assumed as 100. The contact angle with water was shown to be 5°.

### EXAMPLE 5

| | |
|---|---|
| SiO₂ | 78.04 Kg |
| Na₂CO₃ | 9.56 Kg |
| CaCO₃ | 5.50 Kg |
| Na₂B₂O₄•5H₂O | 15.23 Kg |
| ZnO | 8.50 Kg |
| K₂CO₃ | 18.90 Kg |
| KNO₃ | 6.00 Kg |
| Quartz-feldspar porphyry | 46.62 Kg |

The glass composition was manufactured by mixing these ingredients homogeneously, followed by melting at the temperature of 1,300° C. to 1,400° C., molding the vitrified product and then cooling gradually. The ratio of far infrared radiation was found to be 88 to 90% relative to the radiation emitted from the perfect black body, which is assumed as 100. The contact angle with water was shown to be 5°.

### EXAMPLE 6

| | |
|---|---|
| SiO₂ | 60.00 Kg |
| Na₂CO₃ | 2.50 Kg |
| Na₂B₂O₄•5H₂O | 35.00 Kg |
| Al(OH)₃ | 4.92 Kg |
| ZnO | 4.00 Kg |
| H₃BO₃ | 13.00 Kg |
| Li₂CO3 | 0.50 Kg |
| Fe₂O₃ | 2.00 Kg |
| Quartz-feldspar porphyry | 30.00 Kg |

The glass composition was manufactured by mixing these ingredients homogeneously, followed by melting at the temperature of 1,300° C. to 1,400° C., molding the vitrified product and then cooling gradually. The ratio of far infrared radiation was found to be 87 to 89% relative to the radiation emitted from the perfect black body, which is assumed to be 100. The contact angle with water was shown to be 4°.

### EXAMPLE 7

| | |
|---|---|
| SiO₂ | 62.30 Kg |
| Na₂CO₃ | 30.05 Kg |
| CaCO₃ | 7.25 Kg |
| Na₂B₂Oa•5H₂O | 4.21 Kg |
| NaNO₃ | 1.60 Kg |
| Al(OH)₃ | 3.20 Kg |
| TiO₂ | 2.00 Kg |
| ZnO | 1.00 Kg |
| KNO₃ | 2.30 Kg |
| Magnetite | 15.00 Kg |

The glass composition was manufactured by mixing these ingredients homogeneously, followed by melting at the temperature of 1,300° C. to 1,400° C., molding the vitrified product and then cooling gradually. The ratio of far infrared radiation was found to be 87 to 88% relative to the radiation emitted from the perfect black body, which is assumed as 100. The contact angle with water was shown to be 6°.

In the present example, it was recognized that the glass was clarified and obtained as being bubble-free without using a clarifier hazardous to the human body such as As₂O₃, Sb₂O₃ and the like. With regard to the quartz-feldspar porphyry glass composition of the present example and publicly-known general glass products, results of tests complying with the elution test of alkali ingredients from glass products according to the JIS standard showed that as little as 0.7 mg of alkali ingredients was eluted for the quartz-feldspar porphyry glass product of one example of the present invention, while 2 mg of alkali ingredients was eluted for the publicly-known general glass. This means that the elution of the far-infrared emitting ingredients is extremely little, in other words, that the far infrared emission effect sustains for a long duration of time. It is therefore considered that the stability of the internal structure of the glass is quite improved for the glass composition of the present invention. This made it possible to prevent a phenomenon that Na+, K+ and the like in the glass product is eluted from the glass surface, resulting from the conversion of non-cross-linked oxygen in the glass structure contained in the glass product into cross-linked oxygen and the like and to maintain features of the present invention for a long duration of time.

The glass product of the present example has a total radiation ratio within the wavelength range from 2.5 to 30 pm, which is a wavelength range of far infrared radiation beneficial to various organisms, of 87 to 89%, and a radiation energy of 3.50×102 to 3.58×102 W/m2. Consequently, it comes to be clear to have a radiation efficiency much higher than the far infrared radiation efficiency of the general soda-lime glass, which is 60 to 70%. In addition, it was found from the measurement of angle of contact with water droplet on the glass composition of Example 1 and on the soda-lime glass of Comparative Example, using a contact angle meter (product of Kyowa Interface Science Co., Ltd.: Model CA-X150), that the glass of the present invention was remarkably hydrophilic, with an angle of contact with water droplet of approximately 4°, while the soda-lime glass had an angle of contact with water droplet of approximately 62°, as shown in FIGS. 2 and 3. This demonstrates that the glass of the present invention can more effectively exert the far infrared radiation effect on liquid containing the water. invention is a fuel device having first glass balls which contain to 50M % of a quartz-feldspar porphyry and 50 to 99 wt % of a glass composition mainly composed of SiO2; and second glass balls which contain 1 to 50 wt % of magnetite and 50 to 99 wt % of a glass composition mainly composed of SiO2, characterized by the first 8 glass balls and the second glass balls being filled in a cylindrical container having a fuel inlet and a fuel outlet.

### EXAMPLE 8

Use of Radiator Coolant Device Containing Glass Composite Balls

A radiator coolant device containing the two types of glass composite beads in the shape of spheres was tested in a number of vehicles. The gas consumption of each car was measured without the coolant device and with the coolant device in the radiator reservoir. The results are shown in the table below.

TABLE 1

| Year | | | |
|---|---|---|---|
| Manufacturer | Gas Consumption | Gas Consumption | Fuel Saved by |
| Model and | Without Coolant | With Coolant | Using Coolant |
| Engine Size | Device (Km/L) | Device (Km/L) | Device (%) |
| 1990 Volvo 240 | 7 | 10.2 | 45.7 |
| 2400 cc | | | |
| 2003 Mitsubishi | 10.6 | 12.8 | 20.8 |
| Lancer 1500 cc | | | |
| 1996 Toyota | 5.8 | 7.1 | 22.4 |
| Granvia 3400 cc | | | |
| 2001 Toyota bB | 12.8 | 14.5 | 13.3 |
| 1500 cc | | | |
| 1992 Toyota L | 5.8 | 6.6 | 13.8 |
| Cruiser 4200 cc | | | |
| 1998 Toyota | 8.9 | 9.9 | 11.2 |
| Harrier 3000 cc | | | |
| 1995 Fuji L | 10.0 | 12.0 | 20.0 |
| Wagon 660 cc | | | |
| 1996 Daihatsu | 8.0 | 9.0 | 12.5 |
| Fulltime 660 cc | | | |
| 1994 Mazda | 10.7 | 12.1 | 13.1 |
| Cappella Wagon | | | |
| 1600 cc | | | |
| 2001 Honda | 18.7 | 21.8 | 16.6 |
| Insight 1000 cc | | | |
| 2000 Chevrolet | 5.0 | 6.0 | 20.0 |
| Blazer 4200 cc | | | |
| 2000 Daihatsu | 8.0 | 10.0 | 33.3 |
| Attley 660 cc | | | |
| 1992 Toyota | 8.0 | 10.0 | 25.0 |
| Crown 2000 cc | | | |
| 1993 Toyota | 11.0 | 14.0 | 27.2 |
| Crown 2400 cc | | | |

What is claimed is:

1. A device for exposure to a fluid used as a liquid coolant component in an internal combustion engine cooling circuit, the device comprising:
a housing that defines a chamber and at least one conduit fluidly coupling the chamber to the coolant; and
a composition disposed in the chamber and comprised of a far infrared emitting material.

2. The device of claim 1 wherein the composition is comprised of SiO₂, and at least one compound selected from the group consisting of Na₂CO₃, CaCO₃, Na₂B₂O₄.5H₂O, NaNO₃, Al(OH)₃, TiO₂, ZnO, KNO₃, NaNO₃, Li₂CO₃, K₂CO₃, and AlPO₄.

3. The device of claim 1 wherein the composition is comprised of SiO₂, Na₂CO₃, CaCO₃, Na₂B₂O₄.5H₂O, NaNO₃, Al(OH)₃, TiO₂ and ZnO.

4. The device of claim 1 wherein the composition is comprised of SiO₂, Na₂CO₃, CaCO₃, Na₂B₂O₄.5H₂O, NaNO₃, Al(OH)₃, TiO₂, ZnO, and Li₂CO₃.

5. The device of claim 1 wherein the composition is comprised of SiO₂, Na₂CO₃, CaCO₃, Na₂B₂O₄.5H₂O, NaNO₃, Al(OH)₃, TiO₂, ZnO, and Fe₂O₃.

6. The device of claim 1 wherein the composition is comprised of SiO₂, Al(OH)₃, AlPO₄, and Li₂CO₃.

7. The device of claim 1 wherein the composition is comprised of SiO₂, Na₂CO₃, CaCO₃, Na₂B₂O₄.5H₂O, K₂CO₃, KNO₃, Al(OH)₃, and ZnO.

8. The device of claim 1 wherein the composition is comprised of SiO₂, Na₂CO₃, Na₂B₂O₄.5H₂O, Al(OH)₃, H₃BO₃, ZnO, Li₂CO₃, and Fe₂O₃.

9. The device of claim 1 wherein the composition is comprised of SiO₂, Na₂CO₃, CaCO₃, Na₂B₂O₄.5H₂O, NaNO₃, Al(OH)₃, TiO₂, ZnO, and KNO₃.

10. The device of claim 1 wherein the composition comprises a plurality of beads.

11. The device of claim 1 wherein the composition is formed in a matrix.

12. The device of claim 1 wherein composition comprises one of about 1-50 wt % of a quartz-feldspar porphyry as the far infrared emitting material, about 1-50 wt % of a magnetite as the far infrared emitting material, or about 1-50 wt % combined of quartz-feldspar porphyry and magnetite as the far infrared emitting material.

13. The device of claim 1 wherein the chamber defines two fluid conduits with the composition operatively disposed between the two fluid conduits.

14. An internal combustion engine comprising:
a liquid fluid cooling circuit having at least a portion thereof exposed to a device comprising a housing that defines a chamber exposed to the coolant; and a composition disposed in the chamber and comprised of a far infrared emitting material.

15. The internal combustion engine of claim 14 wherein the composition is further comprised of SiO₂, and at least one compound selected from the group consisting of Na₂CO₃, CaCO₃, Na₂B₂O₄.5H₂O, NaNO₃, Al(OH)₃, TiO₂, ZnO, KNO₃, NaNO₃, Li₂CO₃, K₂CO₃, and AlPO₄.

16. The internal combustion engine of claim 14 wherein the composition is further comprised of SiO₂, Na₂CO₃, CaCO₃, Na₂B₂O₄.5H₂O, NaNO₃, Al(OH)₃, TiO₂ and ZnO.

17. The internal combustion engine of claim 14 wherein the composition is further comprised of SiO₂, Na₂CO₃, CaCO₃, Na₂B₂O₄.5H₂O, NaNO₃, Al(OH)₃, TiO₂, ZnO, and Li₂CO₃.

18. The internal combustion engine of claim 14 wherein the composition is further comprised of SiO₂, Na₂CO₃, CaCO₃, Na₂B₂O₄.5H₂O, NaNO₃, Al(OH)₃, TiO₂, ZnO, and Fe₂O₃.

19. The internal combustion engine of claim 14 wherein the composition is further comprised of SiO₂, Al(OH)₃, AlPO₄, and Li₂CO₃.

20. The internal combustion engine of claim 14 wherein the composition is further comprised of SiO₂, Na₂CO₃, CaCO₃, Na₂B₂O₄.5H₂O, K₂CO₃, KNO₃, Al(OH)₃, and ZnO.

21. The internal combustion engine of claim 14 wherein the composition is further comprised of SiO₂, Na₂CO₃, Na₂B₂O₄.5H₂O, Al(OH)₃, H₃BO₃, ZnO, LiCO₃, and Fe₂O₃.

22. The internal combustion engine of claim 14 wherein the composition is further comprised of SiO₂, Na₂CO₃, CaCO₃, Na₂B₂O₄.5H₂O, NaNO₃, Al(OH)₃, TiO₂, ZnO, and KNO₃.

23. The internal combustion engine of claim 14 wherein the composition is formed into a plurality of beads.

24. The internal combustion engine of claim 14 wherein the composition is formed in a matrix.

25. The internal combustion engine of claim 14 wherein the composition comprises one of about 1-50 wt % of a quartz-feldspar porphyry as the far infrared emitting material, about 1-50 wt % of a magnetite as the far infrared emitting material, or about 1-50 wt % combined of quartz-feldspar porphyry and magnetite as the far infrared emitting material.

26. The internal combustion engine of claim 14 wherein the chamber defines two fluid conduits with the composition operatively disposed between the two fluid conduits.

27. A reservoir for use in a liquid fluid cooling circuit of an internal combustion engine, the reservoir comprising:
a fluid impervious envelope defining a cavity and having at least one conduit to expose the cavity to the fluid of the fluid cooling circuit; and
a composition disposed in the cavity and comprised of a far infrared emitting material.

28. The reservoir of claim 27 wherein the reservoir is a radiator.

29. The reservoir of claim 27 wherein the reservoir is a radiator overflow receptacle.

30. The reservoir of claim 27 wherein the reservoir is part of the engine.
